(19) United States
(12) Patent Application Publication
(10) Pub. No.: US 2022/0152533 A1
(43) Pub. Date: May 19, 2022

(54) FILTER MEDIUM FOR DEACTIVATING PATHOGENS AND/OR ALLERGENS

(71) Applicant: Carl Freudenberg KG, Weinheim (DE)

(72) Inventors: Ulrich Stahl, Laudenbach (DE); Uwe Haefner, Kehl (DE); Heiko Schacht, Weinheim (DE)

(21) Appl. No.: 17/530,518

(22) Filed: Nov. 19, 2021

(30) Foreign Application Priority Data
Nov. 19, 2020 (DE) 10 2020 130 584.2

(51) Int. Cl. B01D 39/08; B01D 46/54

(52) U.S. Cl. CPC B01D 39/08; B01D 46/543; B01D 2239/0654; B01D 2257/91; B01D 2239/0618; B01D 46/546

(57) ABSTRACT

The present invention relates to a filter medium, a filter arrangement for the filtration of gas-particle systems comprising such a filter medium, a method for depleting pathogens and/or allergens from the air and other gases by means of such a filter medium, and the use of the filter medium for depleting pathogens and/or allergens from the air and other gases. The filter medium includes at least one acid-functionalized layer comprising at least one carrier material and at least one fruit acid having a pks1 value of 0 to 7. The at least one acid-functionalized layer is free of added C₈ to C₁₈ fatty acids and their esters and amides thereof. The at least one acid-functionalized layer contains the at least one fruit acid in an amount of 2 wt. % to 30 wt. %, based on the total weight of the at least one acid-functionalized layer.

### CROSS-REFERENCE TO PRIOR APPLICATION

Priority is claimed to German Patent Application No. DE 10 2020 130 584.2, filed on Nov. 19, 2020, the entire disclosure of which is hereby incorporated by reference herein.

### FIELD

The present invention relates to a filter medium, a filter arrangement for the filtration of gas-particle systems comprising such a filter medium, a method for depleting pathogens and/or allergens from the air and other gases by means of such a filter medium, and the use of the filter medium for depleting pathogens and/or allergens from the air and other gases.

### BACKGROUND

It is known to use filtration systems in ventilation systems, e.g., of buildings or vehicles, to reduce the air content of undesirable particulate components, such as allergenic components and pathogenic microorganisms.

Allergens are substances that are recognized by the immune system as “foreign” and are consequently controlled to protect against a possible disease. If certain regulatory mechanisms of the immune system are disturbed, excessive reactions to actually harmless allergens occur with the typical symptoms of an allergy, such as rhinitis allergica or allergic bronchial asthma. Statistics show that the number of persons affected by hypersensitivity responses triggered by allergens increases from year to year. A plurality of allergens are transmitted by air and absorbed by breathing. Such inhalation allergens (i.e., aeroallergens) may be of plant, animal, or human origin (e.g., chemical). These include pollen, fungal spores, flour, wood dust, house dust, animal mite droppings, animal hair, etc. Significant causes of allergies are grass and birch pollen. The number of people affected by massive allergic reactions, and asthmatics in particular, is increasing from year to year, so there is a continued need for filter systems that reliably remove allergens from indoor air or reduce their allergenic effect.

In practice, for example, filter media treated with polyphenols are used to reduce the allergy-causing potential of the substances separated on the filter media. Thus, EP2879776 discloses the use of an allergen deactivator comprising a filter substrate which contains polyphenols from the family of tannins, in particular organic tannic acids, as an anti-allergenic agent. However, polyphenols have the disadvantage that, for example on filters, they have a comparatively low anti-allergenic potential over a longer period of time. Polyphenols as secondary plant substances have a predominantly hydrophilic character and can therefore be degraded or washed out by aging processes (e.g., major temperature and humidity fluctuations) in the course of the filter's service life. In addition, the filter substrate may contain zinc oxide as an antibacterial agent.

EP 3 162 425 describes a filter material for removing allergens from air. The filter material comprises an acid-functionalized layer comprising a fruit acid and a fatty acid. It has been found that washing out of the fruit acid is reduced by fatty acids.

Pathogens are microorganisms or subcellular exciters that cause harmful processes in other organisms. These may be bacteria, viruses, or fungi, among other things.

Viruses are infectious organic structures that spread as virions outside cells (i.e., extracellular) by transmission, but viruses can only replicate within a suitable host cell (i.e., intracellular). The viruses themselves do not consist of one or more cells. All viruses contain the program for their replication and propagation (some viruses also contain other auxiliary components) but have neither independent replication nor their own metabolism and are therefore dependent on the metabolism of a host cell. The viruses attach to surface molecules of the host cells and introduce their genetic material into them. This penetrates into the cell nucleus and alters the cell's own DNA. A possibly massive replication of the virus body (genome and proteins) occurs in the infected cell by the existing cell organelles.

A viral particle outside of cells is referred to as virion. Virions are particles that contain nucleic acids—either deoxyribonucleic acids (DNA) or ribonucleic acids (RNA)—and usually have an enclosing protein capsule (i.e., capsid). However, a capsule is lacking, for example, in the influenza virus, which instead has a ribonucleoprotein. Some virions additionally possess an encapsulation through a biomembrane whose lipid bilayer is interspersed with viral membrane proteins. This is called the viral envelope. Viruses that temporarily have a viral envelope in addition to the capsid until the replication phase begins are referred to as enveloped, and viruses without such an envelope are referred to as non-enveloped.

The diameter of virions is about 15 nm (e.g., Circoviridae) to 440 nm (e.g., Megavirus chilensis). Virions are significantly smaller than bacteria, but slightly larger than viroids, which have neither a capsid nor a viral envelope.

Coronaviruses (CoV) are “enveloped viruses” that belong to the subfamily Coronavirinae in the family Coronaviridae. They can cause illnesses ranging from the common cold to more severe diseases such as Middle East Respiratory Syndrome (MERS-CoV) or Severe Acute Respiratory Syndrome (SARS-CoV). The novel coronavirus SARS-CoV-2 is a new strain that has not been detected in humans in the past.

Bacteria occur in various external forms. Their size is very different. Their diameter is between approximately 0.1 and 700 μm; in most known types, it is approximately 0.6 to 1.0 μm. Their length is within a larger range. Individual cells are between about 0.6 μm and 700 μm long. Bacteria can actively or passively penetrate into a human or animal host and multiply there. Many bacterial infections are harmless, but depending on the germ and especially on the localization and immunity, they can also be very dangerous. After the incubation period has elapsed, the human organism reacts with disease. Bacteria can be absorbed from the environment, for example via breathing or the food. A variety of pathogenic bacteria are airborne and can be ingested by humans or animals primarily through the mucosa of the respiratory tract.

Filter materials are known from the prior art not only for purifying the air of allergens but also from pathogens.

DE 10 2016 212 056 describes a filter medium based on a cationic ion exchanger and an anti-pathogenic substance, e.g., polyphenols. The ion exchanger forms an acidic environment with water, in combination with the anti-pathogenic substance, this combination is harmful to some microorganisms. It is explicitly mentioned that the acidic protons reduce or stop the biological activity of bacteria, germs, fungi, and algae (and not viruses). This is intended to solve the problem that arises with filter media, especially in vehicle air conditioning systems, in that these special microorganisms can multiply in the filter material itself. This is different from viral pathogens, which are only biologically active and able to replicate in the presence of host cells.

To clean the air of viral pathogens, it is known to use filter masks for the field of single respiratory protection applications. Individual filter materials for cleaning the air in stationary and mobile air treatment systems (e.g., filter systems for room air cleaning or vehicle air conditioning) are also known from the prior art.

DE 10 2013 021 071 A1 describes a filter medium, in particular for filtering air for the interior of motor vehicles, comprising an antimicrobial and an antiallergenic substance. The antimicrobial substance is selected from a variety of different compounds, such as metals and metal compounds, etc. The filter medium should be able to kill microorganisms, especially fungi and fungal spores, and at the same time effectively prevent fouling of the filter medium by bacteria, fungi, and other microorganisms.

U.S. Pat. No. 5,888,527 describes an antifungal, antibacterial and antiviral filter comprising a dust-collecting filter fleece with a finish of a tea extract. This filter should be capable of binding and inactivating viruses and preventing them from spreading again.

DE 10 2015 103 284 describes a vacuum cleaner filter bag which has one or more non-woven filter layers as a wall. The vacuum cleaner filter bag further comprises an antimicrobial material, which may be incorporated, for example, in one of the nonwoven filter layers or may be located in an additional insert forming a type of bag, reservoir or sachet inside the vacuum cleaner filter bag. The antimicrobial material is selected from lactic acid, citric acid, tartaric acid, oxalic acid, salicylic acid or derivatives thereof. However, no information is provided on the amount of antimicrobial material used. The essence of the teaching of this document is that when the vacuum cleaner is started up, the liner or filter fleece layer in the dust bag, in which the incorporated antimicrobial materials are located, ruptures and thus the material is distributed inside the dust bag.

US 2013/0183879 describes a composition for the deactivation of allergens, containing diphenyl oxide disulfonate compounds of the formula I

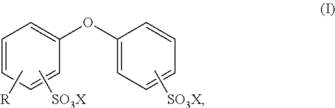

wherein R stands for a C₁-C₃₀ alkyl as allergen deactivating agent. In addition, the composition may contain further auxiliary agents, such as organic acids, EDTA and C₁-C₆ alcohols. The organic acids serve to enhance the anti-allergenic effect by lowering the pH value. This in turn is said to promote the allergen deactivation efficiency of the compound of formula (I). The substance for deactivating allergens can be used in or on a filler, fabric, nonwoven or fiber (i.e., a carrier material), specifically mentioning a spray application on filters of air conditioning systems and for the interior of motor vehicles. The acid is used in an amount of 0.5 wt. % to 50 wt. % relative to the composition. The quantity of acid relative to the carrier material is not mentioned. In the example section, especially the comparative example 1 (Table 1), it is shown that the use of the acid alone (with EDTA and alcohol) without the compound of formula (I) leads to very poor removal of allergens. Thus, this example teaches away from the teachings of the present disclosure, which exclusively uses acid in the substrate. Furthermore, examples 1 to 6 (Table 1) show that the efficiency of allergen removal depends on the number of carbons of the radical R and on whether the side chain R is branched or linear.

DE 683115 describes a vacuum cleaner filter soaked with salicylic acid or interspersed with salicylic acid crystals.

There is currently an immense demand for filter media that are suitable for effectively removing pathogens and allergens from the air or other gases. This applies in particular to filter media that are suitable for effectively reducing the content of pathogenic viruses in the air, especially coronaviruses, such as SARS-CoV-2 or MERS-CoV, and influenza viruses, such as the influenza virus A variant H1N1.

The disclosure addresses a need based on the task of providing a filter medium that can be used to remove pathogens and allergens from air and gases. In particular, the pathogens and allergens should not only be separated on and/or in the filter medium, but also inactivated. On the one hand, this has the advantage that even if the air exiting the filter medium still contains pathogenic/allergenic material, it is inactivated and no longer pathogenic/allergenic. In addition, the loaded filter medium also essentially has no more pathogenic/allergenic material. In addition, the filter medium should specifically have a bactericidal effect and thus remain hygienic and odorless for a long period of time.

### SUMMARY

In an embodiment, the present disclosure provides a filter medium that includes at least one acid-functionalized layer comprising at least one carrier material and at least one fruit acid having a pks1 value of 0 to 7. The at least one acid-functionalized layer is free of added C₈ to C₁₈ fatty acids and their esters and amides thereof. The at least one acid-functionalized layer contains the at least one fruit acid in an amount of 2 wt. % to 30 wt. %, based on the total weight of the at least one acid-functionalized layer.

The object is achieved by the filter medium according to the invention, which has at least one special acid-functionalized layer, as well as the method according to the invention for purifying air.

The use according to the invention has especially the advantage of an antiviral effect of the filter media over different strains of viruses, e.g., H1N1 and HCoV229E.

A first object of the present disclosure is a filter medium comprising or consisting of at least one acid-functionalized layer comprising at least one carrier material and at least one fruit acid having a pks1 value of 0 to 7, wherein the at least one acid-functionalized layer is free of added C₈ to C₁₈ fatty acids, esters and amides thereof.

Another object of the present disclosure is a filter medium comprising or consisting of at least one acid-functionalized layer comprising at least one carrier material and at least one fruit acid having a pks1 value of 0 to 7, said at least one acid-functionalized layer being free of added C₈ to C₁₈ fatty acids, esters and amides thereof, wherein said acid-functionalized layer contains said fruit acid in an amount of 5 wt. % to 30 wt. %, based on the total weight of the acid-functionalized layer.

A further subject matter of the present disclosure is a filter assembly for the filtration of gas-particle systems, comprising

A) a particle-filtering region, comprising
a particle filter support layer, and
a microfiber layer and/or membrane filter layer arranged on the particle filter support layer,
where appropriate, a cover layer arranged on the side of the microfiber layer and/or membrane filter layer facing away from the particle filter support layer; and/or

B) an absorbent region, comprising
an adsorption layer, and
an adsorption support layer arranged on the adsorption layer,

wherein at least one layer selected from the particle filter support layer, microfiber layer, membrane filter layer, cover layer, adsorption layer, and adsorption support layer is formed from a filter medium according to the invention.

Another object is a method for depleting pathogens and/or allergens from the air or other gases, comprising the steps of

i) feeding air or gas enriched with pathogens and/or allergens into a filter device comprising at least one filter medium according to the invention,

ii) passing the air or gas through the filter medium or bringing the air or gas into contact with the filter medium to obtain pathogen and/or allergen depleted air or pathogen and/or allergen depleted gas,

iii) discharging the pathogen and/or allergen depleted air or the pathogen and/or allergen depleted gas from the filter device.

A further object is the use of the filter medium according to the embodiments disclosed herein for the removal of pathogens and/or allergens from the air of buildings, parts of buildings and mobile facilities, preferably for the removal of viruses from the supply air and/or the circulating air and/or the exhaust air of buildings, parts of buildings and mobile facilities, in particular for the removal of pathogens and/or allergens from the interiors of transport facilities, such as road vehicles, rail vehicles, water vehicles or aircraft.

### DETAILED DESCRIPTION

Within the meaning of the present disclosure, depletion of pathogens and allergens is also understood to mean their inactivation. Air or other gases containing pathogens and/or allergens are passed through the filter medium. In this process, at least part of the pathogens/allergens contained in the air or gas is bound by the filter medium, thus reducing the pathogen/allergen concentration by physical separation. In addition, at least some of the pathogens/allergens contained in the air or gas are inactivated by contact with the acid-functionalized layer (i.e., chemical deactivation), so that they are no longer allergenic or pathogenically active. Even if this proportion of inactivated pathogens/allergens is not completely retained in the filter medium, inactivation also reduces the concentration of pathogens/allergens in the air or gas. By means of the filter medium according to the invention, air or gases can be obtained which are free of pathogens and allergens or contain them in a concentration which is so low that an allergic reaction or an infection of people after contact, especially inhalation of this air or gases, or even after a longer stay in rooms containing this air or gases, is excluded. Pathogens and allergens are essentially completely removed by the filter medium according to the invention.

Preferably, in the case of air or gases laden with pathogenic viruses, a viral pathogen reduction factor of preferably >3.0 log levels, particularly preferably >5.0 log levels, is achieved by contacting the filter medium. This reduction in the pathogenicity is based on the deactivation of the viruses by the acid-functionalized layer. The determination of anti-viral properties can be performed according to ISO 18184:2019-06 for the determination of the anti-viral activity of textile products or comparable methods. Measurement of the deactivating ability of the filter media of the invention to specific allergens can be performed by ELISA (enzyme-linked immunosorbant assay) assays, where the allergen concentration can be measured by measuring the color change due to an antigen-antibody reaction. The measurement of the deactivation capacity of the filter media according to the invention with respect to certain bacteria can be carried out according to the ISO 20743:2013 standard.

The filter medium according to the invention is generally suitable for depleting pathogens, in particular viruses and bacteria, and allergens from a gas or a mixture of two or more different gases. A preferred gas mixture is air. The filter medium according to the invention is also advantageously suitable for depleting pathogens, in particular viruses and bacteria, and allergens from respirable gas mixtures other than air. Such breathable gas mixtures preferably contain oxygen and at least one inert gas which is not involved in the metabolic processes and serves to dilute the oxygen. Suitable inert gases are nitrogen, helium, neon and hydrogen.

According to the invention, it was found that at least one acid-functionalized layer comprising at least one fruit acid with a pks1 value of 0 to 7 makes it possible to provide a filter medium with a high capacity for deactivating pathogens and allergens, wherein the at least one acid-functionalized layer is free of added C₈ to C₁₈ fatty acids, their esters and amides. It was assumed that washing out of the fruit acid is reduced by the C₈ to C₁₈ fatty acids. In practical experiments, it has now been found that the filter medium according to the invention exhibits excellent deactivation of viruses even without added fatty acid, and washing out takes place only to a small extent. This is combined with a biocidal effect with respect to other microorganisms and an antiallergenic effect.

Pathogens within the meaning of the invention are, in particular, viruses, bacteria, fungi, and algae. The filter medium according to the invention is specifically suitable for depleting pathogenic viruses and bacteria.

Viruses within the meaning of the invention are enveloped and unenveloped viruses.

Enveloped viruses are preferably selected from coronaviridae, orthomyxoviridae, and pneumoviridae.

Coronaviridae are preferably selected from coronavirus 229E (HCoV-229E), coronavirus NL63 (HCoV-NL63), coronavirus OC43 (HCoV-OC43), coronavirus HKU1 (HCoV-HKU1), MERS-CoV (Middle East respiratory syndrome-related coronavirus) and SARS-associated coronavirus (SARS-CoV)—with subtype SARS-CoV-2, specifically COVID-19.

Orthomyxoviridae are preferably selected from influenza virus A, influenza virus B, influenza virus C, and influenza virus D.

Influenza virus A is specifically influenza virus A variant H1N1, influenza virus A variant H3N2, and influenza virus A variant H5N1.

Influenza virus B is specifically influenza virus B/Victoria lineage and influenza virus B/Yamagata lineage.

Pneumoviridae specifically are respiratory syncytial virus (HRSV) (types A, B) and metapneumovirus (HMPV) (types A1 to 2, B1 to 2).

Unenveloped viruses are specifically selected from Picornaviridae.

Picornaviridae are specifically selected among coxsackievirus A/B, coxsackievirus B1 (CVB-1), echovirus, enterovirus, and rhinovirus.

Rhinoviruses are especially rhinoviruses-1 A (HRV-1 A), 1 B to 100.

A preferred embodiment is the use of the filter medium as defined above and below for depletion of coronaviridae and orthomyxoviridae from air and gases, in particular for depletion of SARS-associated coronavirus, Middle East Respiratory Syndrome-related coronavirus (MERS-CoV) and influenza virus A from air and gases, in particular for depletion of SARS-CoV-2, MERS-CoV and influenza virus A variant H1N1.

Bacteria can reach the host via various routes of infection. Bacterial pathogens in the sense of the invention reach the host specifically as droplet infections via the respiratory air. The filter medium according to the invention is advantageously suitable for depleting bacteria in the air and other gases. In particular, it also has a high capacity for deactivating pathogenically effective bacteria.

Another object of the invention is therefore the use of the filter medium according to the invention for depleting bacteria, preferably selected from pneumococci, hemolytic streptococci, Haemophilus influenzae, Staphylococcus aureus, Moraxella spp, Pseudomonas aeruginosa, etc. These specifically include beta-hemolytic Streptococcus pyrogenes (Group A Streptococci), Corynebacterium diphtheriae, Haemophilus influenzae type b, Bordetella pertussis, Streptococcus pyogenes (Lancefield Group A Streptococci).

For the purposes of this application, allergens are generally substances that can trigger hypersensitivity reactions (i.e., allergic reactions) via the immune system. Another object of the embodiments of the present disclosure is the use of the filter medium for the removal of allergens in the air and other gases. Allergens transmitted by the air and absorbed by the breathing are referred to as inhalation allergens or aeroallergens. In particular, the filter medium also has a high capacity for deactivating such inhalation allergens. The allergens may be of plant, animal or human origin. These include, for example, pollen, fungal spores, flour, wood dust, house dust, animal mite droppings, animal hair, etc. The filter medium is specifically used to remove pollen, such as grass and birch pollen.

The filter medium used comprises at least one acid-functionalized layer comprising a fruit acid having a pks1 value of 0 to 7.

The pKs value (i.e., acid constant) is a measure of the strength of an acid. The lower its pKs value, the greater the acidity.

The pKs values can be determined via acid-base titrations and determination of the pH at the half-equivalence point. Here, the acid and its corresponding base are present in the same concentration. At this point, it follows from the Henderson-Hasselbalch equation: pH=pKs.

The fruit acid preferably has a pks1 value of 1.0 to 5.0, in particular 2.0 to 4.0, and especially 2.5 to 4.0.

Fruit acids are organic hydroxycarboxylic acids, dicarboxylic acids and tricarboxylic acids, although some fruit acids can be classified as hydroxycarboxylic acids as well as dicarboxylic acids or tricarboxylic acids.

Suitable hydroxy acids are selected from fumaric acid, gluconic acid, glycolic acid, mandelic acid, lactic acid, salicylic acid, α-hydroxycaprylic acid and mixtures thereof.

Suitable dicarboxylic acids are selected from malic acid, oxalic acid, tartaric acid, and mixtures thereof.

A preferred tricarboxylic acid is citric acid.

In a preferred embodiment, the fruit acid is selected from malic acid, citric acid, fumaric acid, gluconic acid, glycolic acid, mandelic acid, lactic acid, oxalic acid, salicylic acid, α-hydroxycaprylic acid, tartaric acid, and mixtures thereof. The fruit acid particularly preferably comprises or consists of citric acid.

According to the embodiments of the present disclosure, the at least one acid-functionalized layer is free from added C₈ to C₁₈ fatty acids, their esters and amides.

For the purposes of the disclosure, “free of added C₈ to C₁₈ fatty acids, their esters and amides” means that said fatty acids and their derivatives are not added during the preparation of the at least one acid-functionalized layer. However, it may well be that the fatty acids and derivatives thereof mentioned are already present in the starting materials of the filter medium. Even then, it is preferred that the at least one acid-functionalized layer is substantially or completely free of C₈ to C₁₈ fatty acids and their esters and amides. Preferably, therefore, the acid-functionalized layer contains C₈ to C₁₈ fatty acids, their esters and amides in an amount in the range from 0 to 0.00005 wt. %, based on the total weight of the acid-functionalized layer, particularly preferably from 0 to 0.00001 wt. %, based on the total weight of the acid-functionalized layer, especially from 0 wt. %, based on the total weight of the acid-functionalized layer.

Fatty acids are saturated or mono- or polyunsaturated aliphatic monocarboxylic acids with a mostly unbranched carbon chain. The fatty acids not contained in the filter medium according to the invention, or only contained in the very small amounts mentioned above, are, for example, C₈ to C₁₈ fatty acids with predominantly linear alkyl radicals or predominantly linear alkenyl radicals, such as also occur in natural or synthetic fatty acids, which may be saturated or which may be mono-, di-, tri-, tetra-, penta- or hexa-unsaturated. These include especially also fatty acids that are selected from C₈ to C₁₆ fatty acids and mixtures thereof. A particular embodiment is saturated linear C₁₂ to C₁₄ fatty acids and mixtures thereof. Another particular embodiment is saturated linear C₈, C₁₀, and C₁₂ fatty acids and mixtures thereof. For example, the fatty acid is selected from caprylic acid, pelargonic acid, capric acid, undecanoic acid, lauric acid, tridecanoic acid, myristic acid, pentadecanoic acid, palmitic acid, and mixtures thereof. Fatty acid derivatives are, for example, fatty acids containing hydroxy groups as functional residues, as well as fatty acid esters, fatty acid amides (such as oleic acid amides and stearic acid amides) and/or mixtures thereof.

The filter medium preferably has a weight ratio of fruit acids to C₈ to C₁₈ fatty acids and their esters and amides of at least 10000:1, particularly preferably at least 50000:1, in particular at least 100000:1, specifically at least 500000:1.

The amount of fruit acid in the acid-functionalized layer can be adjusted depending on the desired performance of the filter medium. Preferably, the proportion of fruit acid in the acid-functionalized layer is from 2 wt. % to 30 wt. %, more preferably from 5 wt. % to 30 wt. %, preferably from 2 wt. % to 24 wt. %, even more preferably from 6 wt. % to 18 wt. %, even more preferably from 7 wt. % to 15 wt. %, and in particular from 8 wt. % to 12 wt. %, in each case based on the total weight of the acid-functionalized layer. The total weight of the acid-functionalized layer comprises fruit acid, C₈ to C₁₈ fatty acids, their esters and amides, carrier material and, if present, binders, wetting agents and other additives.

The filter medium comprises at least one acid-functionalized layer or consists of at least one acid-functionalized layer. In order to produce the acid-functionalized layer, a carrier material can be impregnated and/or coated with at least one fruit acid. The layer to be functionalized can be provided with the fruit acid in various ways known to the person skilled in the art, such as by impregnation and/or coating, for example by patting, padding, spraying and/or dipping. Thus, the layer to be functionalized can be impregnated and/or coated in a simple manner with a solution and/or suspension containing fruit acid. Also conceivable is impregnation and/or coating of the layer with a mixture of binders, for example a thermoplastic binder, containing the fruit acid.

In another embodiment, the fruit acid is used in the form of a pourable or free-flowing solid to produce the acid-functionalized layer. The fruit acid can thereby be dry-dispersed into the carrier material. The resulting filter media have the advantage of easy production, as the pourable or free-flowing solid is easy to handle.

In particular, the free-flowing fruit acid is a granulate. Suitable granulates are in the form of a powder, spheres, grains, particles, as dust or mixtures thereof. The granulate preferably has a diameter of 200 to 700 μm. This diameter is also referred to as grain size. When using granules with a particle size >700 μm, an even distribution of the acids over the surfaces of the filter medium is usually achieved. The acids are present in particular in a concentration of 2-250 g/m², particularly preferably of 20-25 g/m².

In a preferred embodiment, the acid-functionalized layer comprises:

at least one fruit acid having a pks1 value from 0 to 7,

at least one carrier material,

where appropriate, at least one binder,

where appropriate, at least one wetting agent, and

optionally, at least one additional additive, for example selected among allergen-eliminating compounds, fungicides, etc.,

wherein the at least one acid-functionalized layer is free of added C₈ to C₁₈ fatty acids, their esters and amides.

Preferably, nonwovens, wovens, knitted fabrics and/or papers can be used as carrier materials for the acid-functionalized layer. A particularly preferred embodiment thus comprises designing the acid-functionalized layer as an impregnated and/or coated nonwoven fabric, as an impregnated and/or coated woven fabric, knitted fabric and/or paper. In this case, the use of a nonwoven material is particularly preferred.

The filter medium comprises at least one acid-functionalized layer or consists of at least one acid-functionalized layer. The filter medium can have a single-layer or multilayer structure. In a first embodiment, the filter medium consists of at least one acid-functionalized layer as previously described. In a further embodiment, the filter medium consists of at least one acid-functionalized layer as previously described and at least one layer different therefrom. The at least one layer different from the acid-functionalized layer is preferably also free from added C₈ to C₁₈ fatty acids and their esters and amides. In a suitable embodiment, the filter medium is present as a two-layer or multi-layer fabric. This fabric then has, for example, at least one acid-functionalized ply and at least one other ply selected, for example, from nonwovens, scrims, wovens, knits, knitted fabrics, papers, and combinations thereof.

For the purposes of the disclosure, nonwoven fabric means a structure of fibers of limited length, continuous fibers (i.e., filaments) or cut yarns of any kind and origin, which have been joined together in any way to form a fiber layer or pile and bonded together in any way, excluding the interlacing or entangling of yarns as occurs in weaving, knitting, lacemaking, braiding, and manufacture of tufted products. Nonwovens also do not include films and papers.

In a particularly preferred embodiment, during the production of the filter medium, the layer to be functionalized is treated with a surfactant as a wetting agent, preferably one or more nonionic surfactants as wetting agents, even more preferably with ethoxylated sorbitan fatty acid esters (polysorbates). Polysorbates that are approved as food additives in the European Union on the basis of Regulation (EC) No 1333/2008 of the European Parliament and of the Council of Dec. 16, 2008, such as E 432, E 434, E 435 and E 436, are particularly preferred.

In particular, the filter medium is free of polyoxyethylene(20)-sorbitan monooleate (polysorbate 80, E433).

For the purposes of the disclosure, “free polyoxyethylene (20)-sorbitan monooleate (polysorbate 80, E433)” means that the at least one acid-functionalized layer is substantially or completely free of polyoxyethylene (20)-sorbitan monooleate. Preferably, therefore, the acid-functionalized layer contains polyoxyethylene (20)-sorbitan monooleate in an amount in the range of 0 to 0.00005 wt. %, based on the total weight of the acid-functionalized layer, particularly preferably 0 to 0.00001 wt. %, based on the total weight of the acid-functionalized layer, especially 0 wt. %, based on the total weight of the acid-functionalized layer. The advantage of using wetting agents is that the fruit acid can be anchored particularly well on the layer to be functionalized. This enables good immobilization and deactivation of the pathogens and/or allergens. With regard to the use of odor-intensive active substances, the surfactant offers the additional advantage that the immobilization of these substances can also reduce odor release.

The fitter medium may also contain other allergen-eliminating compounds, such as polyphenols, in particular flavonoids, phenolic acids, polyhydroxyphenols, anthocyanins, procyanidins, benzoic acid derivatives and stilbene derivatives, preferably of natural origin, such as the secondary plant compounds found in pomegranate, gingko or grape seed flour and/or mixtures thereof. These compounds are preferably present in an amount of 2% to 20%, in each case based on the total weight of the filter medium.

The filter medium may also contain fungicidal active ingredients. For this purpose, the acid-functionalized layer can be treated with a fungicidal substance, preferably with triazoles such as, in particular, 2-octyl-2H-isothiazol-3-one and/or metals and their compounds, e.g., zinc pyrithiones.

In a further embodiment, the filter medium according to the invention is free of added diphenyl oxide disulfonate derivatives, in particular free of compounds of the formula (I)

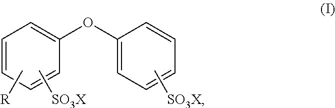

### Wherein:

R is linear or branched C₁-C₃₀ alkyl, and

### X is H, Na, K, Mg or Ca.

R is preferably linear or branched C₁₀-C₂₅ alkyl, in particular, linear C₁₀-C₂₅ alkyl.

In a preferred embodiment, the filter medium is free of compounds of the formula (I), where R is linear C₆-alkyl, linear C₁₀-alkyl, linear C₁₂-alkyl, branched C₁₂-alkyl, linear C₁₆-alkyl or branched C₂₂-alkyl and X is H, Na, K, Mg or Ca.

In a preferred embodiment, the filter medium is free of disodium hexadecyl diphenyloxide disulfonate.

For the purposes of the disclosure, “free compounds of formula (I)” means that the at least one acid-functionalized layer is substantially or completely free of compounds of formula (I). Preferably, therefore, the acid-functionalized layer contains compounds of the formula (I) in an amount in the range from 0 to 0.00005 wt. %, based on the total weight of the acid-functionalized layer, particularly preferably from 0 to 0.00001 wt. %, based on the total weight of the acid-functionalized layer, especially from 0 wt. %, based on the total weight of the acid-functionalized layer.

The filter medium is excellently suited for use as a filter medium for depleting pathogens and/or allergens, in particular viruses, from the air of buildings, parts of buildings and mobile equipment. On the one hand, this includes the air exchanged between the building, the part of the building or the mobile equipment and the outside world, specifically the fresh air supplied (e.g., outside air) and the exhaust air discharged (e.g., exhaust air). In order to protect the people located in the building, building part, or mobile equipment, the fresh air is generally filtered in order to reduce the proportion of viruses against the outside air. This furthermore includes the air circulated in the building, the building part, or the mobile equipment (i.e., circulating air). In order to reduce the amount of pathogens and/or allergens, especially viruses, in the room air, the circulating air is usually filtered as well. In order to protect the people located outside the building, building part or the mobile equipment, it may also be expedient to filter the discharged outgoing air. In a preferred embodiment, the filter medium is used in a room air conditioning system. These include systems without a ventilation function, such as recirculation systems and recirculation air conditioning systems, and systems with a ventilation function, such as ventilation systems and air conditioning systems. In another preferred embodiment, filter media is used in an air handling system of a transportation device, such as road vehicles, rail vehicles, watercraft or aircraft. The transportation device is preferably selected from passenger cars, buses, trucks, trains, ships and aircraft. Preference is given to the use of the filter medium according to the invention for the removal of pathogens and/or allergens, in particular viruses, in the interiors of transportation devices, such as road vehicles, rail vehicles, water vehicles or aircraft. Particularly preferred is the use of the filter medium according to the invention for the removal of pathogens and/or allergens, especially viruses, in the passenger compartments of motor vehicles.

Advantageously, the loaded filter medium also essentially has no more pathogenic/allergenic material. Used filter materials can thus be disposed of without any problems according to usual procedures, e.g., thermally.

Viruses and bacteria may be present in the air and in other gases in the form of aerosols (i.e., particulate suspended particles), where the viruses and bacteria themselves may form the aerosol particles or may be attached to other particulate aerosol components, such as dust, water droplets, etc. Filters in ventilation systems are usually in the form of filter arrangements that comprise several filter components and often have particle-filtering areas in addition to absorbing areas. It is thus possible to also effectively clean complex gas-particle systems. The flat substrate is advantageously suitable as a filter medium for use in such filter arrangements.

Another object of the present disclosure is a filter arrangement comprising a filter medium as described above. In a preferred embodiment, the filter arrangement comprises a particle-filtering region and/or an absorbing region, wherein the filter medium may be comprised by one or both of these regions.

In a particularly preferred embodiment, the filter arrangement has the following components:

A) a particle-filtering region, comprising:

a particle filter support layer,

a microfiber layer and/or membrane filter layer arranged on the particle filter support layer, and

where appropriate, a cover layer arranged on the side of the microfiber layer and/or membrane filter layer facing away from the particle filter support layer; and/or

B) an absorbent region, comprising

an adsorption layer, and

an adsorption support layer disposed on the adsorption layer, wherein at least one layer selected from particle filter support layer, microfiber layer, membrane filter layer, cover layer, adsorption layer and adsorption support layer is formed from a filter medium as described above.

According to the disclosure, “particle filter support layer” means a layer that can serve as a support layer for a microfiber layer and/or membrane filter layer.

According to the disclosure, “membrane filter layer” means a layer that is a permeable membrane.

According to the disclosure, “cover layer” means a layer that can serve to cover and protect the microfiber layer and/or membrane filter layer.

According to the disclosure, adsorption layer means a layer comprising an adsorbent. This is preferably selected from the group consisting of activated carbon particles, zeolites, ion exchangers and mixtures thereof. The adsorbent is advantageously arranged in the adsorption layer in a statistically random manner as a flowable packed layer on the adsorption carrier layer.

According to the disclosure, adsorption carrier layer means a layer that can serve as a carrier layer for the adsorption layer.

The adsorbing region of the filter arrangement can also consist of a geometrically determined arrangement of the adsorbent, for example as a flow-through honeycomb body of defined cell geometry and/or use of a geometrically defined support structure for mechanical stabilization of an adsorption layer.

It is conceivable that the filter arrangement comprises only the particle-filtering region or the absorbing region. Advantageously, however, the filter arrangement has both the particle-filtering region and the absorbing region, as this provides a particularly effective filter arrangement. In this case, the two regions are preferably arranged such that the adsorption layer is located on the side of the microfiber layer, membrane filter layer or cover layer facing away from the particle filter support layer. Furthermore, the filter arrangement in use is preferably arranged such that the particle-filtering region is upstream of the absorbing region with respect to the direction of flow. In this way, active substances present in the absorbing region, for example fruit acid, can be protected from being covered with foreign particles from the supply air.

According to the embodiments of the present disclosure, at least one layer selected from particle filter support layer, microfiber layer, membrane filter layer, cover layer, adsorption layer and adsorption support layer is formed from a filter medium as described above and thus has the fruit acid. The specific designs of the filter medium described above can be transferred to the respective corresponding layers of the filter arrangement. In principle, only a single layer or also different layers of the filter arrangement can have the fruit acid.

The advantage of introducing the fruit acid into the particle filter support layer is that it usually faces the air stream as the first layer of the filter arrangement, and thus allergen-containing particles and dusts of the air stream can be deactivated before penetrating into the deeper layers of the filter arrangement.

In a preferred embodiment, the fruit acid is contained in the cover layer. The advantage of this embodiment is that the upstream layers in the filter arrangement are not affected in terms of their filtering properties. In addition, the fruit acid can also be protected from exposure to foreign particles from the supply air. This arrangement may be even more advantageous if the fruit acid is not present in either the particle filter support layer, the microfiber layer, or the membrane filter layer.

The advantage of introducing the fruit acid into the adsorption layer is that adsorption layers generally provide high specific surface areas (approximately 1000 m²/g when using activated carbon) and therefore a large reactive surface area is available for pathogen/allergen deactivation. In addition, the fruit acid can also be protected from exposure to foreign particles from the supply air by the particle-filtering region or by the adsorption support layer.

The advantage of introducing the fruit acid into the adsorption support layer is that the filter properties of the upstream layers in the filter arrangement are not influenced by the introduction of the fruit acid into the adsorption support layer. In addition, the fruit acid can be protected from coating with foreign particles from the supply air through the particle-filtering region.

In a particularly preferred embodiment, the filter arrangement has the following structure with respect to the flow direction: a particle filter support layer, a microfiber layer, an adsorption layer, and an adsorption support layer. In use, the particle filter support layer is advantageously arranged on the upstream side.

As explained above, the carrier materials for the particle filter support layer, microfiber layer, membrane filter layer, cover layer and adsorption support layer can advantageously be nonwovens, woven fabrics, knitted fabrics and/or papers.

It has also proved suitable to set the proportion of fruit acid in the filter arrangement at from 5 wt. % to 30 wt. %, preferably from 5 wt. % to 24 wt. % even more preferably from 5 wt. % to 18 wt. % even more preferably from 5 wt. % to 15 wt. % and in particular from 5 wt. % to 12 wt. %, in each case based on the total weight of the filter arrangement.

In a preferred embodiment, the adsorption support layer and/or the particle filter support layer comprises a nonwoven fabric, preferably selected from spunbonded nonwovens, having an average fiber diameter in the range from 20 to 70 μm, preferably from 20 to 50 μm, in particular from 20 to 50 μm and/or staple fiber nonwovens having an average fiber diameter from 5 to 60 μm, preferably from 10 to 50 μm, in particular from 10 to 35 μm and/or an average fiber length from 10 to 100 mm, preferably from 30 to 80 mm. Further advantageously, the microfiber layer and/or membrane filter layer comprises a nonwoven fabric, preferably selected from meltblown fiber nonwovens with an average fiber diameter of 1 μm to 10 μm. Advantageously, the cover layer comprises a nonwoven, preferably selected from spunbonded nonwovens, with an average fiber diameter in the range from 20 to 60 μm and/or staple fiber nonwovens with an average fiber diameter of 10 to 50 μm.

A particularly preferred embodiment comprises designing the adsorption support layer, the particle filter support layer, the microfiber layer, the membrane filter layer, and/or the cover layer as a nonwoven impregnated and/or coated with the fruit acid, as described above.

Another object of the present disclosure is a method for depleting pathogens and/or allergens from the air or other gases, comprising the steps of:

i) feeding air or gas enriched with pathogens and/or allergens into a filter device comprising at least one filter medium as previously defined,

ii) passing the air or gas through the filter medium or bringing the air or gas into contact with the filter medium to obtain pathogen and/or allergen depleted air or pathogen and/or allergen depleted gas, and

iii) discharging the pathogen and/or allergen depleted air or the pathogen and/or allergen depleted gas from the filter device.

In particular, the depletion of pathogens and/or allergens in the air or other gases is performed by circulating air.

A further object of the present disclosure is the use of the filter medium for the removal of pathogens and/or allergens from the air of buildings, parts of buildings and mobile facilities, preferably for the removal of viruses from the supply air and/or the circulating air and/or the exhaust air of buildings, parts of buildings and mobile facilities, in particular for the removal of pathogens and/or allergens from the interiors of transport facilities, such as road vehicles, rail vehicles, water vehicles or aircraft.

In particular, the filter medium can be used to deplete SARS-associated coronavirus, MERS-CoV and influenza virus A from air and other gases, and more specifically to deplete SARS-CoV-2, MERS-CoV and influenza virus A variant H1N1 from air and other gases.

In particular, the filter medium can be used for depletion of bacteria selected from pneumococci, hemolytic streptococci, Haemophilus influenzae, Staphylococcus aureus, Moraxella spp, Pseudomonas aeruginosa, etc., especially beta-hemolytic Streptococcus pyrogenes (group A streptococci), Corynebacterium diphtheriae, Haemophilus influenzae type b, Bordetella pertussis and Streptococcus pyogenes (Lancefield group A streptococci).

In particular, the filter medium can be used to remove allergens selected from pollen, fungal spores, flour, wood dust, house dust, animal mite excrement and animal hair.

The embodiments of the present disclosure are explained with reference to the following examples, which are not limiting.

### Examples

A carrier nonwoven made of polyester spunbonded fabric (surface weight 60 g/m²) was given an antiviral finish with citric acid. The antiviral doping of the carrier fleece was carried out by applying an aqueous solution of the active ingredient to the carrier fleece and subsequent drying of the now finished fleece in order to obtain a sample for analysis. The nonwoven thus equipped contained citric acid in a weight amount of 10 mg based on 100 mg nonwoven.

The size of the samples used in the test was 20 mm×20 mm. The anti-viral activity was tested analogously to ISO 18184:2019-06 on three samples each. Each sample cut into 20 mm×20 mm pieces was soaked in solutions of known initial viral concentration of viral strains A/PR8/34 H1N1 and HCoV229E at 25° C. After two hours of soaking, the supernatant was pipetted off, the viral concentration in each sample was determined, and from this the mean viral pathogen reduction factor was determined as a log value and the antiviral efficacy as a percentage.

For A/PR8/34 H1N1, a log value of 5.89 was determined according to an anti-viral efficacy of >99.99 percent.

A log value of 5.33 was determined for HCoV-229 E.

While the embodiments of the present disclosure have been described in detail in the foregoing description, such description is to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the embodiments refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A filter medium, comprising:
at least one acid-functionalized layer comprising at least one carrier material and at least one fruit acid having a pks1 value of 0 to 7, wherein the at least one acid-functionalized layer is free of added C₈ to C₁₈ fatty acids and their esters and amides thereof, wherein said the at least one acid-functionalized layer contains said the at least one fruit acid in an amount of 2 wt. % to 30 wt. %, based on the total weight of said the at least one acid-functionalized layer.

2. The filter medium according to claim 1, wherein the at least one acid-functionalized layer contains C₈ to C₁₈ fatty acids, their esters and amides in an amount of from 0 to 0.00005 wt. %, based on the total weight of the acid-functionalized layer.

3. The filter medium according to claim 1, wherein the filter medium is free of polyoxyethylene(20)sorbitan monooleate (Polysorbate 80).

4. The filter medium according to claim 1, wherein the filter medium is free of compounds of formula (I): 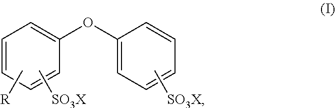
wherein,
R is a linear or branched C₁-C₃₀ alkyl, and
X is H, Na, K, Mg or Ca.

5. The filter medium according to claim 1, wherein the at least one fruit acid is selected from malic acid, fumaric acid, gluconic acid, glycolic acid, mandelic acid, lactic acid, oxalic acid, salicylic acid, α-hydroxycaprylic acid, tartaric acid, citric acid and mixtures thereof.

6. The filter medium according to claim 1, wherein the at least one acid-functionalized layer contains the at least one fruit acid in an amount from 5 wt % to 30 wt % relative to the total weight of the at least one acid-functionalized layer.

7. The filter medium according to claim 1, wherein the at least one acid-functionalized layer additionally contains at least one fungicidal substance different from the at least one fruit acid.

8. The filter medium according to claim 1, wherein the at least one carrier material is selected from nonwovens, wovens, knits, papers and combinations thereof.

9. The filter medium according to claim 1, wherein the at least one acid-functionalized layer comprises an impregnated and/or coated nonwoven.

10. The filter medium according to claim 1, wherein the at least one fruit acid is introduced onto and/or into the at least one acid-functionalized layer in the form of a pourable or free-flowing solid.

11. A filter assembly for filtration of gas-particle systems, comprising:
a particle-filtering region, comprising:
a particle filter support layer, and
a microfiber layer and/or membrane filter layer arranged on the particle filter support layer; and
an absorbent region, comprising:
an adsorption layer, and
an adsorption support layer arranged on the adsorption layer,
wherein at least one layer selected from the particle filter support layer, microfiber layer, membrane filter layer, cover layer, adsorption layer, and adsorption support layer are formed from a filter medium according to claim 1.

12. A method for depleting pathogens and/or allergens from air or other gases, the method comprising:
feeding air or gas enriched with pathogens and/or allergens into a filter device comprising at least one filter medium according to claim 1,
passing the air or gas through the filter medium or bringing the air or gas into contact with the filter medium to obtain pathogen and/or allergen depleted air or pathogen and/or allergen depleted gas,
discharging the pathogen and/or allergen depleted air or the pathogen and/or allergen depleted gas from the filter device.

13. The method according to claim 12, wherein the depletion of the pathogens and/or allergens in the air or other gases is carried out by air circulation.
